(19) United States
(12) Patent Application Publication
(10) Pub. No.: US 2022/0212059 A1
(43) Pub. Date: Jul. 7, 2022

(54) DIRECT WRITE METHOD AND DYNAMIC WORKOUT CONTENT SYSTEM, MARKUP LANGUAGE, AND EXECUTION ENGINE

(71) Applicant: Facebook Technologies, LLC, Menlo Park, CA (US)

(72) Inventors: Stephen Choi, Seattle, WA (US); Kyle Justin Curts, Carnation, WA (US); Mengfei Wang, Woodinville, WA (US); Charles Liam Goudge, Menlo Park, CA (US)

(21) Appl. No.: 17/701,823

(22) Filed: Mar. 23, 2022

Related U.S. Application Data
(60) Provisional application No. 63/165,249, filed on Mar. 24, 2021.
(60) Provisional application No. 63/230,757, filed on Aug. 8, 2021.

(51) Int. Cl. A63B 24/00; G06T 19/00

(52) U.S. Cl. CPC A63B 24/0075; A63B 2230/425; A63B 2230/062; G06T 19/006

(57) ABSTRACT

A method includes irradiating a layer of photosensitive material with a beam of light having a selected polarization orientation, and scanning the beam of light over an iso-phasic contour of a pattern to be formed in the layer of photosensitive material while maintaining the selected polarization orientation. A computer-implemented method includes receiving, by a computer processor, a stream of sensory signals indicating user heart rate and/or respiration rate, accessing a workout script stored in memory, where the workout script has markup applied thereto that specifies one or more actions to be taken in response to the stream of sensory signals, determining, based on the received stream of sensory signals and the markup applied to the workout script, that the user heart rate and/or respiration rate falls outside a target zone, and adjusting content of the workout script in response to the determination.

### CROSS-REFERENCE TO RELATED APPLICATIONS

This application claims the benefit of priority under 35 U.S.C. § 119(e) of U.S. Provisional Application No. 63/165,249, filed Mar. 24, 2021, and Provisional Application No. 63/230,757, filed Aug. 8, 2021, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is a schematic diagram illustrating an example system for the generation of patterned optical elements along iso-phasic contours according to some embodiments.

FIG. 2A illustrates a comparative direct write process according to certain embodiments.

FIG. 3A illustrates an example direct write process according to exemplary embodiments.

FIG. 4A is an illustration of augmented-reality glasses that may be used in connection with embodiments of this disclosure.

FIG. 5A is an illustration of a virtual-reality headset that may be used in connection with embodiments of this disclosure.

FIG. 6B is a flow diagram of an exemplary computer-implemented method for adjusting content of a workout script according to some embodiments.

FIG. 7B is a system block diagram illustrating an exemplary system for adjusting content of a workout script according to some embodiments.

FIG. 8B is a networking block diagram illustrating networked devices implementing an exemplary system for adjusting content of a workout script according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

### Direct Write Method Along Iso-Phasic Contours

The present disclosure is generally directed to the manufacture of patterned birefringent elements, and more particularly to a direct write method for forming patterned birefringent elements along iso-phasic contours. Patterned birefringent elements may be used in a variety of applications, including displays, optical communications, polarization holography, polarimetry, etc. Example patterned birefringent elements may include phase retarders, polarization gratings, and geometric phase holograms, although further structures and applications are contemplated.

In accordance with various embodiments, disclosed are methods for encoding a desired pattern in a photosensitive medium. A direct write (or maskless lithography) technique may be used to selectively alter the composition, structure, and/or one or more properties of a wide range of material layers within a predetermined pattern. In example systems, micro pattern generators optionally employing raster-scan and vector exposure modes may be used to create 2D or 3D (grey scale) structures in relatively thick layers of a photosensitive (e.g., polarization-sensitive) medium. Suitable photosensitive media may include photopolymers such as various azopolymers and photosensitive glasses such multicomponent silicate glasses.

In comparative methods, a pattern may be generated by focusing light into a spot and scanning the spot in at least two directions over a polarization-sensitive recording medium while varying the polarization of the light. However, such a serpentine raster approach typically necessitates rapid polarization orientation changes as the write tool traverses the desired pattern across the grain, i.e., between regions of different targeted exposure and orientation. Moreover, very high-speed polarization modulation and accurate axis synchronization are typically required to achieve satisfactory results.

According to various embodiments, a direct write method for forming a patterned birefringent element may include maintaining a substantially constant output polarization of a scanning beam of light during the successive formation of respective iso-phasic regions of a targeted pattern.

According to various embodiments, patterns may be written by modulating the polarization and traversing a focused beam over a layer of polarization-sensitive medium using a trajectory that is close to (but not necessarily exactly following) the targeted phase contour(s). Traversing along each phase contour separately may beneficially involve less stringent requirements on the polarization modulation and/or axis synchronization such that the fidelity of the resulting pattern (i.e., with respect to the design intent) may be more accurate. In embodiments where the focused spot scans the pattern along iso-phasic contours, the targeted structure can be more accurately defined, and polarization modulation can be decreased. The iso-phasic path may include a serpentine raster scan for a line grating or a half-circle spiral for an axisymmetric pattern, for example.

Features from any of the embodiments described herein may be used in combination with one another in accordance with the general principles described herein. These and other embodiments, features, and advantages will be more fully understood upon reading the following detailed description in conjunction with the accompanying drawings and claims.

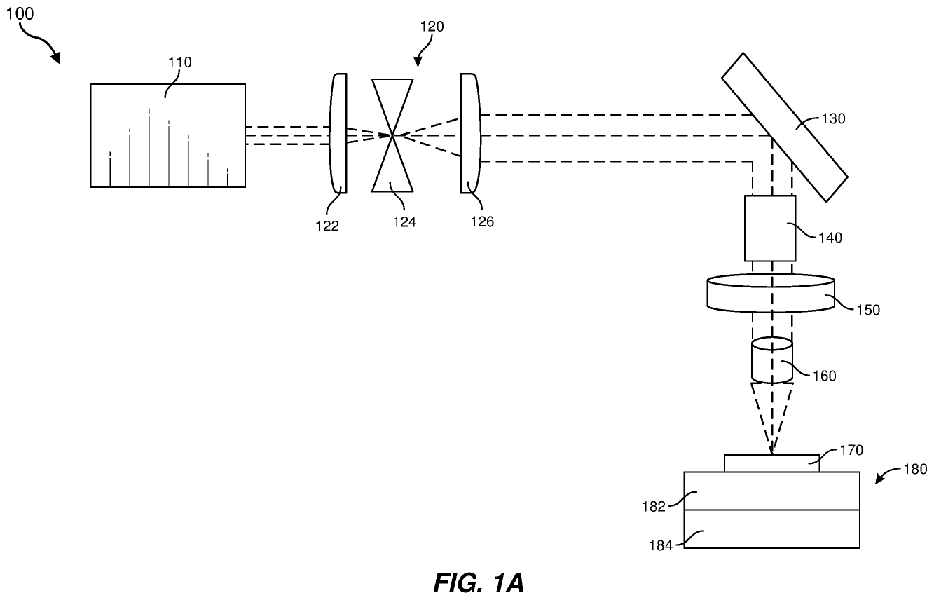

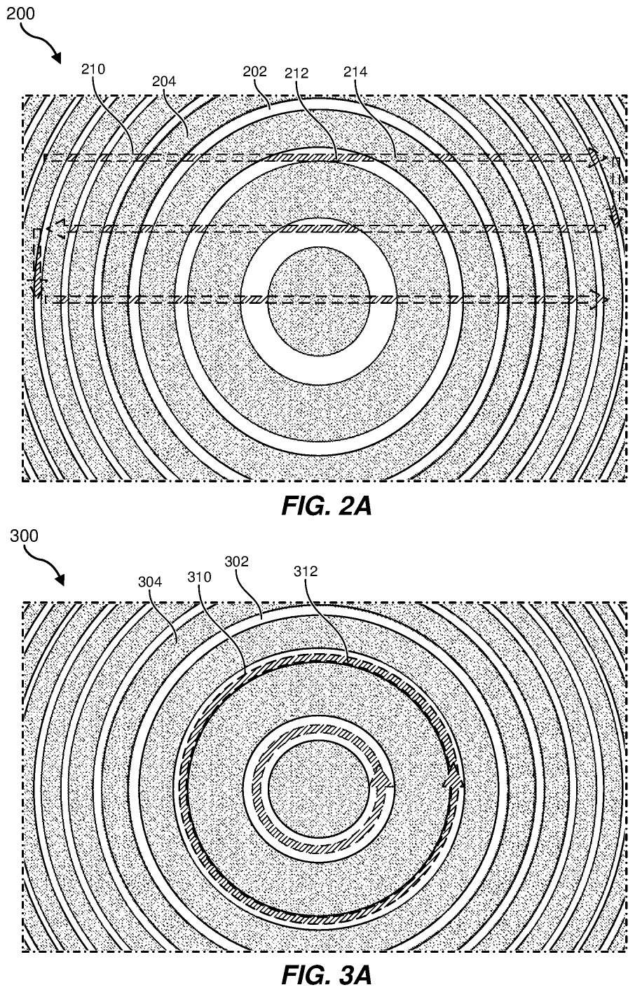

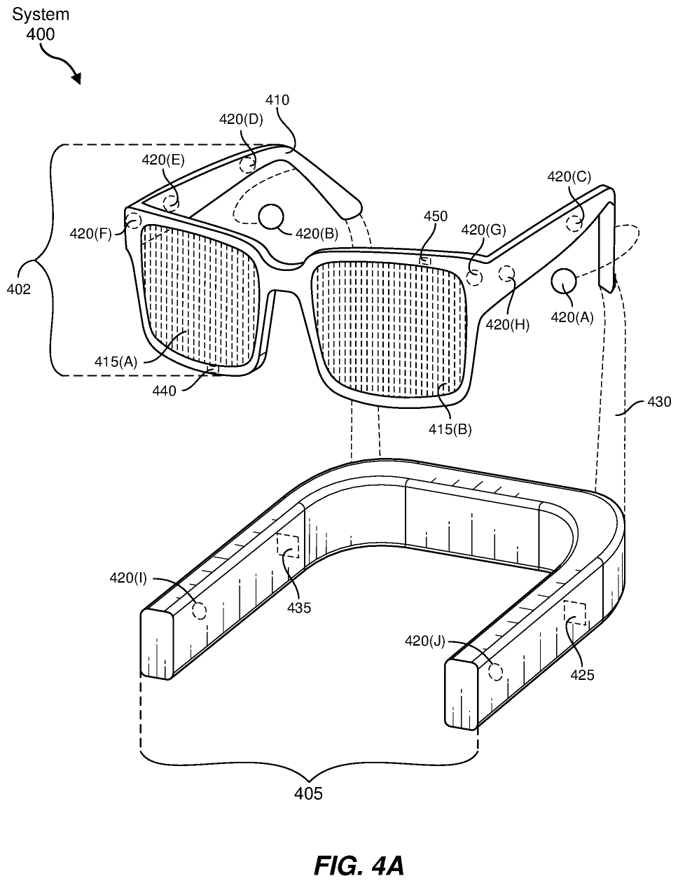

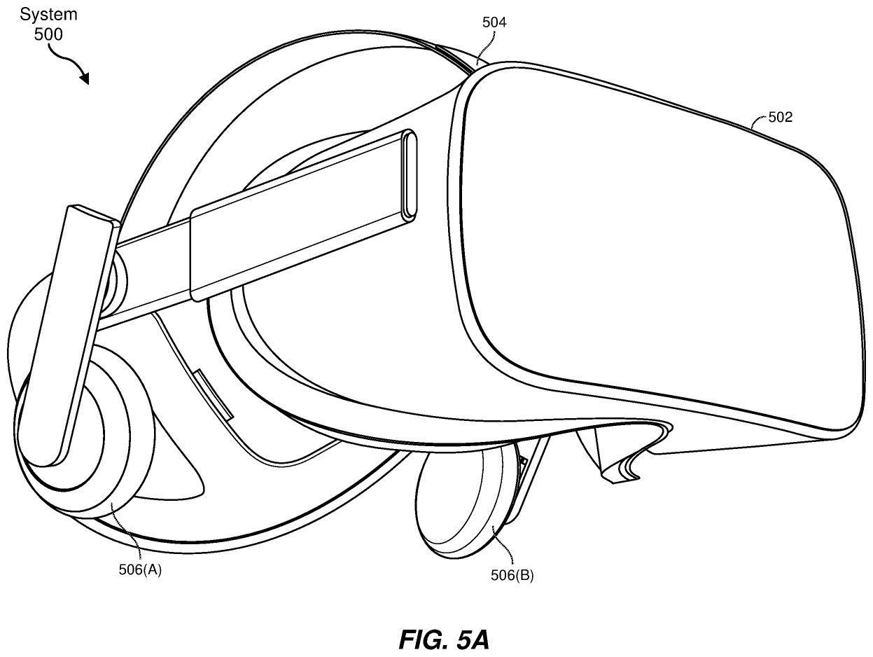

The following will provide, with reference to FIGS. 1A-5A, detailed descriptions of an iso-phasic contour-based direct write manufacturing method. The discussion associated with FIG. 1A includes a description of an example system for implementing such a direct write method. The discussion associated with FIGS. 2A and 3A includes a description of the spatial and temporal controls over the polarization orientation of incident light during such a method. The discussion associated with FIGS. 4A and 5A relates to exemplary virtual reality and augmented reality devices that may incorporate patterned birefringent elements that are manufactured using the disclosed method.

A system for forming a patterned birefringent element is shown schematically in FIG. 1A. System 100 may include a light source 110 such as a laser. The light source 110 may be configured to provide an at least partially collimated light beam and may include an ultraviolet (UV) laser, for example. As illustrated, the light beam produced by light source 110 may be passed through conditioning optics 120, including, but not limited to, a spatial filter 122, a beam expander 124, and a collimating lens 126.

Mirror 130 may be used to direct the collimated beam through a polarizer or polarizing beam splitter 140, such as a Glan-Taylor prism, and a polarization modulator 150, which may include a Pockels cell and a quarter-wave plate, or half wave plate mounted on a rotation stage. The light beam exiting the polarization modulator 150 may be directed onto a sample 170 via focusing lens 160. Focusing lens 160 may be configured to provide a focal spot that is about 1 mm or less in diameter. The sample 170, which may include a layer of polarization-sensitive recording medium, may be mounted on a 2D scanning system 180, which may include a pair of linear translation stages (e.g., x-y translation stages 182, 184).

A comparative method for introducing a pattern into a layer of polarization-sensitive recording medium is shown in FIG. 2A. Method 200 may be used to form a concentric pattern having alternating first phase and second phase regions 202, 204 having respective first and second polarization orientations, although different pattern geometries are contemplated.

The illustrated method 200 may include scanning and simultaneously modulating a beam of light 210 with a serpentine raster pattern that is independent of the phase contours associated with first phase regions 202 and second phase regions 204. That is, in FIG. 2A, the grey scale pattern may represent the modulating birefringence generated by exposing a polarization-sensitive medium with corresponding polarization orientations 212, 214 where the raster pattern may be distinct from the desired pattern for the birefringent element. With such an approach, it will be appreciated that accurate axis synchronization and high-speed polarization modulation, i.e., between a first polarization orientation 212 and a second polarization orientation 214 may be needed to achieve desired results.

In contrast, referring to FIG. 3A and method 300, an analogous structure to that shown in FIG. 2A and including alternating first phase and second phase regions 302, 304 may be formed by traversing a beam along each phase contour. For instance, first phase regions 302 may each be formed substantially in their entirety by scanning a beam 310 having a first polarization orientation 312. In a similar vein, second phase regions 304 may each be formed substantially in their entirety by scanning a beam (not shown) having a second polarization orientation. Scanning along iso-phasic contours in this manner may require less stringent requirements on the polarization modulation and axis synchronization.

Patterned optical elements such as polarization gratings and phase retarders may be used in a variety of applications, including displays and in optical communications. In a direct write process for manufacturing patterned optical elements, a layer of photosensitive medium may be exposed to a beam of polarized light along iso-phasic contours. Traversing the beam along each phase contour separately may impose less stringent requirements on the polarization modulation and/or axis synchronization and improve the fidelity of the resulting pattern compared to a serpentine raster scan where the polarization orientation of the incident beam is rapidly changed as the write tool traverses the desired pattern.

### EXAMPLE EMBODIMENT

Example 1: A method includes irradiating a layer of photosensitive material with a beam of light having a selected polarization orientation, and translating the beam of light over an iso-phasic contour of a pattern to be formed in the layer of photosensitive material while maintaining the selected polarization orientation.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 400 in FIG. 4A) or that visually immerses a user in an artificial reality (such as, e.g., virtual-reality system 500 in FIG. 5A). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 4A, augmented-reality system 400 may include an eyewear device 402 with a frame 410 configured to hold a left display device 415(A) and a right display device 415(B) in front of a user's eyes. Display devices 415(A) and 415(B) may act together or independently to present an image or series of images to a user. While augmented-reality system 400 includes two displays, embodiments of this disclosure may be implemented in augmented-reality systems with a single NED or more than two NEDs.

In some embodiments, augmented-reality system 400 may include one or more sensors, such as sensor 440. Sensor 440 may generate measurement signals in response to motion of augmented-reality system 400 and may be located on substantially any portion of frame 410. Sensor 440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 400 may or may not include sensor 440 or may include more than one sensor. In embodiments in which sensor 440 includes an IMU, the IMU may generate calibration data based on measurement signals from sensor 440. Examples of sensor 440 may include, without limitation, accelerometers, gyroscopes, magnetometers, other suitable types of sensors that detect motion, sensors used for error correction of the IMU, or some combination thereof.

In some examples, augmented-reality system 400 may also include a microphone array with a plurality of acoustic transducers 420(A)-420(J), referred to collectively as acoustic transducers 420. Acoustic transducers 420 may represent transducers that detect air pressure variations induced by sound waves. Each acoustic transducer 420 may be configured to detect sound and convert the detected sound into an electronic format (e.g., an analog or digital format). The microphone array in FIG. 4A may include, for example, ten acoustic transducers: 420(A) and 420(B), which may be designed to be placed inside a corresponding ear of the user, acoustic transducers 420(C), 420(D), 420(E), 420(F), 420(G), and 420(H), which may be positioned at various locations on frame 410, and/or acoustic transducers 420(I) and 420(J), which may be positioned on a corresponding neckband 405.

In some embodiments, one or more of acoustic transducers 420(A)-(J) may be used as output transducers (e.g., speakers). For example, acoustic transducers 420(A) and/or 420(B) may be earbuds or any other suitable type of headphone or speaker.

The configuration of acoustic transducers 420 of the microphone array may vary. While augmented-reality system 400 is shown in FIG. 4A as having ten acoustic transducers 420, the number of acoustic transducers 420 may be greater or less than ten. In some embodiments, using higher numbers of acoustic transducers 420 may increase the amount of audio information collected and/or the sensitivity and accuracy of the audio information. In contrast, using a lower number of acoustic transducers 420 may decrease the computing power required by an associated controller 450 to process the collected audio information. In addition, the position of each acoustic transducer 420 of the microphone array may vary. For example, the position of an acoustic transducer 420 may include a defined position on the user, a defined coordinate on frame 410, an orientation associated with each acoustic transducer 420, or some combination thereof.

Acoustic transducers 420(A) and 420(B) may be positioned on different parts of the user's ear, such as behind the pinna, behind the tragus, and/or within the auricle or fossa. Or, there may be additional acoustic transducers 420 on or surrounding the ear in addition to acoustic transducers 420 inside the ear canal. Having an acoustic transducer 420 positioned next to an ear canal of a user may enable the microphone array to collect information on how sounds arrive at the ear canal. By positioning at least two of acoustic transducers 420 on either side of a user's head (e.g., as binaural microphones), augmented-reality device 400 may simulate binaural hearing and capture a 3D stereo sound field around about a user's head. In some embodiments, acoustic transducers 420(A) and 420(B) may be connected to augmented-reality system 400 via a wired connection 430, and in other embodiments acoustic transducers 420(A) and 420(B) may be connected to augmented-reality system 400 via a wireless connection (e.g., a BLUETOOTH connection). In still other embodiments, acoustic transducers 420(A) and 420(B) may not be used at all in conjunction with augmented-reality system 400.

Acoustic transducers 420 on frame 410 may be positioned in a variety of different ways, including along the length of the temples, across the bridge, above or below display devices 415(A) and 415(B), or some combination thereof. Acoustic transducers 420 may also be oriented such that the microphone array is able to detect sounds in a wide range of directions surrounding the user wearing the augmented-reality system 400. In some embodiments, an optimization process may be performed during manufacturing of augmented-reality system 400 to determine relative positioning of each acoustic transducer 420 in the microphone array.

In some examples, augmented-reality system 400 may include or be connected to an external device (e.g., a paired device), such as neckband 405. Neckband 405 generally represents any type or form of paired device. Thus, the following discussion of neckband 405 may also apply to various other paired devices, such as charging cases, smart watches, smart phones, wrist bands, other wearable devices, hand-held controllers, tablet computers, laptop computers, other external compute devices, etc.

As shown, neckband 405 may be coupled to eyewear device 402 via one or more connectors. The connectors may be wired or wireless and may include electrical and/or non-electrical (e.g., structural) components. In some cases, eyewear device 402 and neckband 405 may operate independently without any wired or wireless connection between them. While FIG. 4A illustrates the components of eyewear device 402 and neckband 405 in example locations on eyewear device 402 and neckband 405, the components may be located elsewhere and/or distributed differently on eyewear device 402 and/or neckband 405. In some embodiments, the components of eyewear device 402 and neckband 405 may be located on one or more additional peripheral devices paired with eyewear device 402, neckband 405, or some combination thereof.

Pairing external devices, such as neckband 405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 400 may be provided by a paired device or shared between a paired device and an eyewear device, thus reducing the weight, heat profile, and form factor of the eyewear device overall while still retaining desired functionality. For example, neckband 405 may allow components that would otherwise be included on an eyewear device to be included in neckband 405 since users may tolerate a heavier weight load on their shoulders than they would tolerate on their heads. Neckband 405 may also have a larger surface area over which to diffuse and disperse heat to the ambient environment. Thus, neckband 405 may allow for greater battery and computation capacity than might otherwise have been possible on a stand-alone eyewear device. Since weight carried in neckband 405 may be less invasive to a user than weight carried in eyewear device 402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 405 may be communicatively coupled with eyewear device 402 and/or to other devices. These other devices may provide certain functions (e.g., tracking, localizing, depth mapping, processing, storage, etc.) to augmented-reality system 400. In the embodiment of FIG. 4A, neckband 405 may include two acoustic transducers (e.g., 420(I) and 420(J)) that are part of the microphone array (or potentially form their own microphone subarray). Neckband 405 may also include a controller 425 and a power source 435.

Acoustic transducers 420(I) and 420(J) of neckband 405 may be configured to detect sound and convert the detected sound into an electronic format (analog or digital). In the embodiment of FIG. 4A, acoustic transducers 420(I) and 420(J) may be positioned on neckband 405, thereby increasing the distance between the neckband acoustic transducers 420(I) and 420(J) and other acoustic transducers 420 positioned on eyewear device 402. In some cases, increasing the distance between acoustic transducers 420 of the microphone array may improve the accuracy of beamforming performed via the microphone array. For example, if a sound is detected by acoustic transducers 420(C) and 420(D) and the distance between acoustic transducers 420(C) and 420(D) is greater than, e.g., the distance between acoustic transducers 420(D) and 420(E), the determined source location of the detected sound may be more accurate than if the sound had been detected by acoustic transducers 420(D) and 420(E).

Controller 425 of neckband 405 may process information generated by the sensors on neckband 405 and/or augmented-reality system 400. For example, controller 425 may process information from the microphone array that describes sounds detected by the microphone array. For each detected sound, controller 425 may perform a direction-of-arrival (DOA) estimation to estimate a direction from which the detected sound arrived at the microphone array. As the microphone array detects sounds, controller 425 may populate an audio data set with the information. In embodiments in which augmented-reality system 400 includes an inertial measurement unit, controller 425 may compute all inertial and spatial calculations from the IMU located on eyewear device 402. A connector may convey information between augmented-reality system 400 and neckband 405 and between augmented-reality system 400 and controller 425. The information may be in the form of optical data, electrical data, wireless data, or any other transmittable data form. Moving the processing of information generated by augmented-reality system 400 to neckband 405 may reduce weight and heat in eyewear device 402, making it more comfortable to the user.

Power source 435 in neckband 405 may provide power to eyewear device 402 and/or to neckband 405. Power source 435 may include, without limitation, lithium ion batteries, lithium-polymer batteries, primary lithium batteries, alkaline batteries, or any other form of power storage. In some cases, power source 435 may be a wired power source. Including power source 435 on neckband 405 instead of on eyewear device 402 may help better distribute the weight and heat generated by power source 435.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 500 in FIG. 5A, that mostly or completely covers a user's field of view. Virtual-reality system 500 may include a front rigid body 502 and a band 504 shaped to fit around a user's head. Virtual-reality system 500 may also include output audio transducers 506(A) and 506(B). Furthermore, while not shown in FIG. 5A, front rigid body 502 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 400 and/or virtual-reality system 500 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 400 and/or virtual-reality system 500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 400 and/or virtual-reality system 500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments. Dynamic Workout Content System, Markup Language, and Execution Engine

With the closure of gyms under COVID, there has been an explosion of home-based workouts. Such workouts tend to be the same “canned” experience for everyone—one size fits all. While users can select different workouts for different levels, there is a lack of personalization that would improve the effectiveness of the experience.

Owners of today's wearables are able to measure performance in a limited way using, for example, counting steps, exercise duration, etc. However, this information is not used in a meaningful way and does not help improve the workout experience. Also, these metrics tend to be displayed “after the fact.”

Many wearables today are now also capable of capturing deeper body biometrics, such as Heart Rate (HR), Respiration Rate (RR), Saturated Oxygen (SpO₂), and/or six degrees of freedom (6DOF) movement data produced by a wearable's micro-electromechanical systems (MEMS) sensor. However, this data is rarely or never streamed in real time.

The present disclosure recognizes that there is an opportunity to use this data if it is streamed raw in real time during the workout to provide the user with a personalized and improved workout experience. Utilizing real-time streaming in this way may provide for a dynamic coach without having to have a live person or coach present during the workout session.

The present disclosure is generally directed to a content markup language that specifies logic for an optimized workout experience. An author of a workout script may apply markup to the content of the script to specify actions to be taken in response to a received stream of sensory signals indicating user heart and/or respiration rate. A range of rate values may define a target zone. If the sensed heart and/or respiration rate exceed the target zone, actions may be taken such as slowing down content, switching to an easier workout module, and/or sending messages to the user to take it easy. If the sensed heart and/or respiration rate fall below the target zone, actions may be taken such as speeding up the content, switching to a more difficult workout module, and/or sending messages to the user to speed up. The disclosed systems and methods allow a user to stay within safe heart rate zones as well as optimal zones for their training. The disclosed systems and methods may also be used for fitness tests by dynamically asking people to perform tasks and observe/record how their bodies react.

Features from any of the embodiments described herein may be used in combination with one another in accordance with the general principles described herein. These and other embodiments, features, and advantages will be more fully understood upon reading the following detailed description in conjunction with the accompanying drawings and claims.

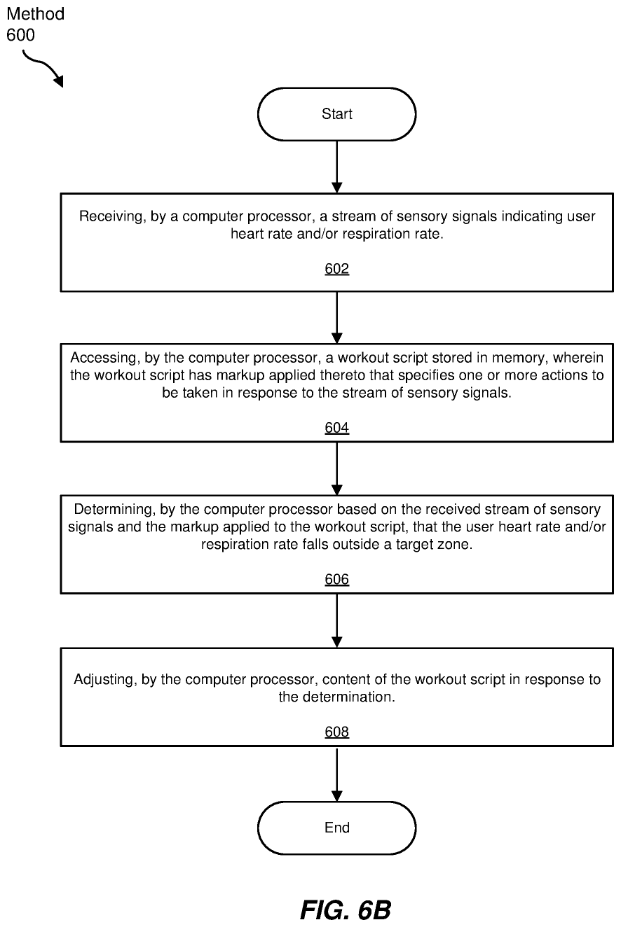

The following will provide, with reference to FIGS. 6B-8B, detailed descriptions of dynamically adjusting content of a workout script in response to a received stream of sensory data. Disclosed implementations include a dynamic workout content system, a markup language, and an execution engine. Advantageously, the disclosed implementations may provide a way to automatically adjust content of a workout to keep a user's heart rate and/or respiration rate in a target zone.

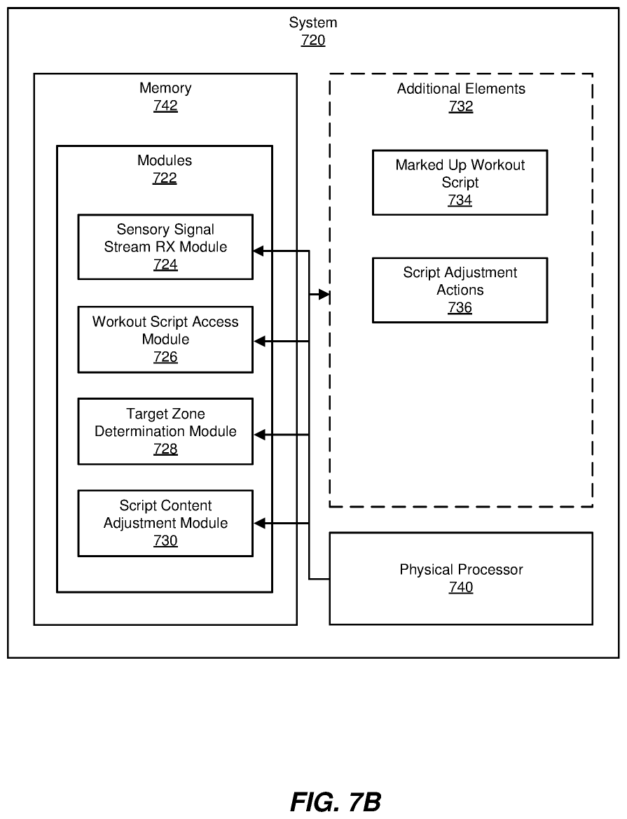

FIG. 6B is a flow diagram of an exemplary computer-implemented method 600 for adjusting content of a workout script. The steps shown in FIG. 6B may be performed by any suitable computer-executable code and/or computing system, including the system(s) illustrated in FIGS. 7B and/or 8B. In one example, each of the steps shown in FIG. 6B may represent an algorithm whose structure includes and/or is represented by multiple sub-steps, examples of which will be provided in greater detail below.

As illustrated in FIG. 6B, at step 602 one or more of the systems described herein may receive, by a computer processor, a stream of sensory signals indicating user heart rate and/or respiration rate. For example, the computer processor may be paired with a user's wearable device via Bluetooth®, and the wearable device may be configured to generate and stream the sensory signals to the computer processor. Alternatively or additionally, the computer processor may receive the stream via any wired or wireless technology, either directly from the user's wearable device or from another device acting as a gateway or intermediary to transmit the stream to the computer processor. In some cases, the sensory signals may be received in a raw format, and the computer processor may be configured to detect a heart rate and/or respiration rate based on the signals of the stream. Alternatively or additionally, the wearable device or another device may detect such rates, and the computer processor may receive a stream of detected rates. Upon receiving the stream, the computer processor may store the sensory data of the stream in one or more buffers for analysis, reference, and/or reporting. Processing may then proceed from step 602 to step 604.

At step 604, one or more of the systems described herein may access, by the computer processor, a workout script stored in memory. The workout script may have markup applied thereto that specifies one or more actions to be taken in response to the stream of sensory signals. The markup may provide a way for a provider of workout content to design a workout script so that it dynamically adjusts to the user of the content. In this way, rather than one experience, the workout can be varied according to the user as the user goes through the workout or training experience. This adaptation allows content to be adjusted if the user exceeds pre-defined limits or when they are just not trying hard enough.

The content markup language may specify the logic for this optimized workout experience, and it may be implemented with tools to manage the content and generate the markup script. For example, the markup language may allow an author to take modules of content comprised, for example, of video, audio, text, and/or graphics, and use the markup language to manage the content and specify logical rules for the rendering of the content. For instance, if the user exceeds a predefined maximum heart rate, the markup may specify one or more actions that may include slowing the content down, switching to an easier workout module, and/or sending messages to take it easy. Conversely, if the user's exertion rate (as measured by heart and/or respiration rate) is below a target zone, the markup may specify one or more actions that may include inserting messages of encouragement to speed up. In a specific example, the markup may be placed at a check point in the content flow as follows:
If HR is below range: play content #1;
If HR is above range: play content #2;
Else keep playing content #0.
   This markup of the workout script may allow users to stay within safe heart rate zones as well as optimal zones for their training. Processing may then proceed from step 604 to step 606.

At step 606, the method 600 includes determining, by the computer processor based on the received stream of sensory signals and the markup applied to the workout script, that the user heart rate and/or respiration rate falls outside a target zone. At a given checkpoint in the script, the markup may specify a target range of heart rate values and/or a target range of respiration rate values. By comparing the user's heart rate and/or respiration rate from the sensory signals to upper and lower thresholds of one or more such ranges, the computer processor may determine if one or more of the user's rates falls outside a respective target range. Moreover, the computer processor may determine if the user's rate or rates are too high (i.e., above an upper threshold) or too low (below a lower threshold). Processing may then proceed from step 606 to step 608.

At step 608, the method 600 further includes adjusting, by the computer processor, content of the workout script in response to the determination at step 606. For example, if a user rate was determined, at step 606, to be too low, the adjusting operation at step 608 may include one or more actions such as inserting messages of encouragement to speed up. Alternatively or additionally, alternative content may be played that instructs the user to perform a more difficult exercise, such as burpees instead of jumping jacks. Conversely, if a user rate was determined, at step 606, to be too low, the adjusting operation at step 608 may include one or more actions such as slowing the content down, switching to an easier workout module (i.e., march in place instead of jumping jacks), and/or sending messages to take it easy. Adjusting the content at step 608 may provide an automated way to keep a user's heart rate and/or respiration rate in a target zone.

FIG. 7B is a block diagram of an example system 720 for adjusting content of a workout script. As illustrated in this figure, example system 720 may include one or more modules 722 for performing one or more tasks. As will be explained in greater detail below, modules 722 may include sensory signal stream RX module 724, a workout script access module 726, a target zone determination module 728, and a script content adjustment module 730. Although illustrated as separate elements, one or more of modules 722 in FIG. 7B may represent portions of a single module or application.

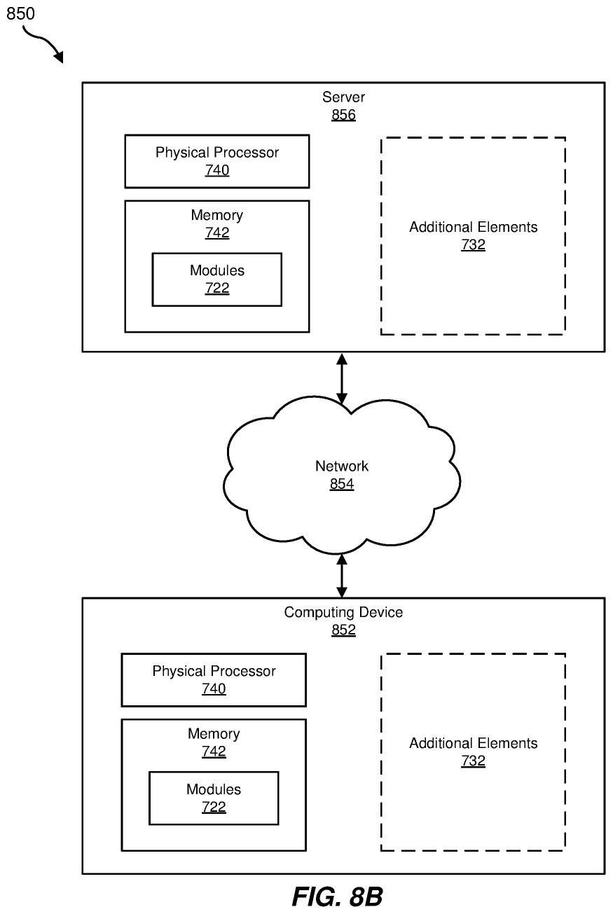

In certain embodiments, one or more of modules 722 in FIG. 7B may represent one or more software applications or programs that, when executed by a computing device, may cause the computing device to perform one or more tasks. For example, and as will be described in greater detail below, one or more of modules 722 may represent modules stored and configured to run on one or more computing devices, such as the devices illustrated in FIG. 8B (e.g., computing device 852 and/or server 856). One or more of modules 722 in FIG. 7B may also represent all or portions of one or more special-purpose computers configured to perform one or more tasks.

As illustrated in FIG. 7B, example system 720 may also include one or more memory devices, such as memory 742. Memory 742 generally represents any type or form of volatile or non-volatile storage device or medium capable of storing data and/or computer-readable instructions. In one example, memory 742 may store, load, and/or maintain one or more of modules 722. Examples of memory 742 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 7B, example system 720 may also include one or more physical processors, such as physical processor 740. Physical processor 740 generally represents any type or form of hardware-implemented processing unit capable of interpreting and/or executing computer-readable instructions. In one example, physical processor 740 may access and/or modify one or more of modules 722 stored in memory 742. Additionally or alternatively, physical processor 740 may execute one or more of modules 722 to dynamically adjust content of a workout script in response a received stream of sensory signals as previously described. Examples of physical processor 740 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 7B, example system 720 may also include one or more instances of stored information, such as additional elements 732. Additional elements 732 generally represents any type or form of information that configures physical processor 740 to perform operations that adjust content of a workout script in response to a stream of sensory signals. In one example, additional elements 732 may include marked up workout script 734 and script adjustment actions 736.

In operation, marked up workout script 734 may cause physical processor 740 to implement modules 722. For example, sensory signal stream RX module 724 may receive a stream of sensory signals in any manner previously described, such as with reference to step 602 of FIG. 6B. Additionally, workout script access module 726 may access the marked up workout script 734 and render content according to the script in the same or similar manner as previously described with reference to step 604 of FIG. 6B. Also, target zone determination module 728 may determine if a user rate is outside a target zone in any manner previously described, such as with reference to step 606 of FIG. 6B. Further, script content adjustment module 730 may adjust the content of the script 734 in any manner previously described, such as with reference to step 608 of FIG. 6B.

Example system 720 in FIG. 7B may be implemented in a variety of ways. For example, all or a portion of example system 720 may represent portions of example system 850 in FIG. 8B. As shown in FIG. 8B, system 850 may include a computing device 852 in communication with a server 856 via a network 854. In one example, all or a portion of the functionality of modules 722 may be performed by computing device 852, server 856, and/or any other suitable computing system. As will be described in greater detail below, one or more of modules 722 from FIG. 7B may, when executed by at least one processor of computing device 852 and/or server 856, enable computing device 852 and/or server 856 to dynamically adjust content of a workout script in response to a stream of sensory signals. For example, and as previously described with reference to FIGS. 6B and 7B, one or more of modules 722 may cause computing device 852 and/or server 856 receive a stream of sensory signals, access a marked-up workout script, determine that a user's heart rate and/or respiration rate is outside one or more target zones, and adjust content of the workout script based on the markup and the determination.

Computing device 852 generally represents any type or form of computing device capable of reading computer-executable instructions. For example, the computing device may be a mobile device, such as a smartphone or tablet. Additional examples of computing device 852 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 856 generally represents any type or form of computing device that is capable of providing configuration information to computing device 852. Additional examples of server 856 include, without limitation, security servers, application servers, web servers, storage servers, and/or database servers configured to run certain software applications and/or provide various security, web, storage, and/or database services. Although illustrated as a single entity in FIG. 8B, server 856 may include and/or represent a plurality of servers that work and/or operate in conjunction with one another.

Network 854 generally represents any medium or architecture capable of facilitating communication or data transfer. In one example, network 854 may facilitate communication between computing device 852 and server 856. In this example, network 854 may facilitate communication or data transfer using wireless and/or wired connections. Examples of network 854 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

As described above, the disclosed content markup language may specify logic for an optimized workout experience. An author of a workout script may apply markup to the content of a script to specify actions to be taken in response to a received stream of sensory signals indicating user heart and/or respiration rate. A range of rate values may define a target zone. If the sensed heart and/or respiration rate exceed the target zone, actions may be taken such as slowing down content, switching to an easier workout module, and/or sending messages to the user to take it easy. If the sensed heart and/or respiration rate fall below the target zone, actions may be taken such as speeding up the content, switching to a more difficult workout module, and/or sending messages to the user to speed up. The disclosed systems and methods may allow a user to stay within safe heart rate zones as well as optimal zones for their training. The disclosed systems and methods may also be used for fitness tests by dynamically asking people to perform tasks and observe/record how their bodies react. Dynamically adjusted tasks may provide a much finer tuned view than a standard test.

It is envisioned that aspects of the disclosed systems and methods may be implemented in various ways. One implementation may be a closed loop system that uses the dynamic workout content as previously described. Another implementation may be a wearable device that streams raw bio data and/or a device that receives the stream and that plays workout content. An additional implementation may be content comprised of multiple modules (e.g., video sequences, audio sequences, text/graphics, background music, etc.). A further implementation may be an execution engine that may consume the content markup and render the appropriate content according to the mark up logic at the right time and/or under the right conditions.

### EXAMPLE EMBODIMENT

Example 2: A method includes: receiving, by a computer processor, a stream of sensory signals indicating at least one of user heart rate or respiration rate; accessing, by the computer processor, a workout script stored in memory, wherein the workout script has markup applied thereto that specifies one or more actions to be taken in response to the stream of sensory signals; determining, by the computer processor based on the received stream of sensory signals and the markup applied to the workout script, that the at least one of user heart rate or respiration rate falls outside a target zone; and adjusting, by the computer processor, content of the workout script in response to the determination.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on,” “over,” or “overlying” another element, it may be located directly on at least a portion of the other element, or one or more intervening elements may also be present. In contrast, when an element is referred to as being “directly on,” “directly over,” or “directly overlying” another element, it may be located on at least a portion of the other element, with no intervening elements present.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a photosensitive material that comprises or includes an azopolymer include embodiments where a photosensitive material consists of an azopolymer and embodiments where a photosensitive material consists essentially of an azopolymer.

What is claimed is:

1. A method comprising:
a process for direct write along iso-phasic contours comprising:
irradiating a layer of photosensitive material with a beam of light having a selected polarization orientation; and
translating the beam of light over an iso-phasic contour of a pattern to be formed in the layer of photosensitive material while maintaining the selected polarization orientation; or
a process for adjusting content of a workout script comprising:
receiving, by a computer processor, a stream of sensory signals indicating at least one of user heart rate or respiration rate;
accessing, by the computer processor, a workout script stored in memory, wherein the workout script has markup applied thereto that specifies one or more actions to be taken in response to the stream of sensory signals;
determining, by the computer processor based on the received stream of sensory signals and the markup applied to the workout script, that the at least one of user heart rate or respiration rate falls outside a target zone; and
adjusting, by the computer processor, content of the workout script in response to the determination.
